(19) United States
(12) Patent Application Publication
(10) Pub. No.: US 2015/0323938 A1
(43) Pub. Date: Nov. 12, 2015

(54) TEMPERATURE-BASED LEVEL DETECTION AND CONTROL METHOD AND APPARATUS

(71) Applicant: Honeywell International Inc., Morristown, NJ (US)

(72) Inventors: Alan B. Levy, Randolph, NJ (US); Bashir Harji, Cambridgeshire (GB)

(73) Assignee: Honeywell International Inc., Morristown, NJ (US)

(21) Appl. No.: 14/273,814

(22) Filed: May 9, 2014

(51) Int. Cl. G05D 9/00

(52) U.S. Cl. CPC G05D 9/00

(57) ABSTRACT

Methods and apparatus for controlling and determining the level of a material in a vessel using one or more temperature sensors are provided.

### FIELD

The present invention relates to methods of level detection and/or control in vessels and in particular methods for detecting and/or controlling an interface based on temperature.

### BACKGROUND

Level control in a liquid-containing chemical reactor is a common control function in continuous reactors. The level control determines the volume of liquid held in the reactor, which together with the flow rate of the liquid through the system determines the residence time. The residence time, in combination with temperature and other reaction parameters, affect the reaction outputs, including, but not limited to, the amount of conversion of the raw materials.

Typical level sensing methods include pressure sensors, guided wave radar, capacitance sensors, vibration and ultrasonic detectors, optical sensors, resistivity sensors, microwave detectors, and nuclear (gamma ray) detectors. However, typical methods use sensors that are too large and/or expensive for use in small vessels. Some sensors detect a fixed level inside a vessel and cannot be easily adjusted. Some sensors have inadequate resolution to detect small changes in the liquid level, which is a typical requirement in relatively small volume vessels. Some level detectors will not withstand being used in particular environments, such as sensors that are made from materials that are unsuitable for aggressive environments, or sensors that include electrical circuitry and current that could be exposed to an explosive environment.

Improvements in the foregoing are desired.

### SUMMARY

The present disclosure provides methods for controlling the level of liquid in a vessel using one or more temperature measuring devices.

In one exemplary embodiment, a method of controlling the level of a material in a vessel is provided. The method includes providing a first temperature sensor at a first position corresponding to a first level of material in the vessel; monitoring the temperature recorded by the first temperature sensor, wherein a change in the monitored temperature indicates that the level of the material in the vessel is substantially at the first level; and adjusting a flow of material into the vessel or a flow of material out of the vessel based on the change in the monitored temperature.

In a more particular embodiment, said adjusting step further includes maintaining the level of the material in the vessel at substantially the first level. In another more particular embodiment, the method further includes continuously adding a first flow rate of the material to the vessel, wherein said adjusting includes increasing or decreasing the flow of the material out of the vessel based on the change in the monitored temperature. In another more particular embodiment, the material is a liquid. In another more particular embodiment, at least a portion of the liquid is evaporated from the vessel. In another more particular embodiment, the method includes continuously stirring the material in the vessel. In a more particular embodiment, the vessel has a nominal volume of about 1 L or less. In another more particular embodiment, the first temperature sensor is a thermocouple, such as a thermocouple formed from stainless steel and having a thickness of 1.6 mm or less.

In another more particular embodiment of any of the above embodiments, adding a second flow rate of a second material is continuously added to the vessel, the second material being chemically different from the first material, wherein an interface is formed between the liquid and the second material at the level of the liquid in the vessel. In a more particular embodiment, the second material is a gas. In a more particular embodiment, the second material is reacted with the first material in the vessel. In another more particular embodiment, the second material is added to the vessel at a position below the interface.

In a more particular embodiment of any of the above embodiments, the temperature sensor is not a heated thermocouple.

In another exemplary embodiment, a method of controlling the level of a first material in a vessel is provided. The method includes receiving a first temperature reading corresponding to a first temperature from a first temperature sensor at a first position corresponding to a first level of the first material in the vessel; receiving a second temperature reading corresponding to a second temperature from a second temperature sensor at a second position corresponding to a second level of material in the vessel, the second level being lower than the first level; adding the first material to the vessel at a first inlet flow rate; removing the first from the vessel at a first outlet flow rate; and adjusting at least one of the first inlet flow rate and the first outlet flow rate based on the difference in the temperatures to maintain the level of the first material in the vessel at substantially the first level.

In a more particular embodiment, the adjusting is based on a comparison of the first and second temperatures, wherein a difference in the compared temperatures indicates that the level of the first material in the vessel is between the first level and the second level. In another more particular embodiment, the adjusting includes increasing the first outlet flow rate when the first temperature is greater than the second temperature and decreasing the first outlet flow rate when the second temperature is greater than the first temperature. In another more particular embodiment, the first temperature oscillates in a range above and below the second temperature, such as about 1° C. or smaller. In another more particular embodiment, the method further includes receiving a third temperature from a third temperature sensor at a third position corresponding to a third level of the first material in the vessel, the third level being higher than the first level.

In a more particular embodiment of any of the above embodiments, the method further includes adding a second material to the vessel at a second inlet flow rate, the second material being chemically different than the first material, wherein an interface is formed between the first material and the second material. In a more particular embodiment, the second material is a gas and adding the second material includes adding the gas to the vessel at a position below the interface.

In a more particular embodiment of any of the above embodiments, the temperature sensor is not a heated thermocouple.

In still another exemplary embodiment, a method of determining the position of an interface between a first material and a second material in a vessel is provided, wherein the second material is chemically different than the first material. The method includes providing a first temperature sensor at a first position corresponding to a first level of the interface in the vessel; providing a second temperature sensor at a second position corresponding to a second level of the interface in the vessel, the second level being lower than the first level; and comparing the temperature recorded by the first temperature sensor and the second temperature sensor, wherein a difference in the temperatures indicates that the level of the interface in the vessel is between the first level and the second level. In a more particular embodiment, the method further includes providing an array comprising a plurality of temperature sensors, each temperature sensor at a predetermined position corresponding to a level of material in the vessel, wherein the plurality of temperature sensors includes the first temperature sensor and the second temperature sensor. In a more particular embodiment, the temperature sensor is not a heated thermocouple.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 illustrates an exemplary level control system including a single thermocouple.

FIG. 2 is a cut-away view of an exemplary thermocouple.

FIG. 3A illustrates the level control system of FIG. 1 in which the interface is below the level of the provided thermocouple.

FIG. 3B illustrates the level control system of FIG. 1 in which the interface is at the level of the provided thermocouple.

FIG. 3C illustrates the level control system of FIG. 1 in which the interface is above the level of the provided thermocouple.

FIG. 4A illustrates an exemplary two-thermocouple level control system in which the interface is below the level of the upper thermocouple.

FIG. 4B illustrates an exemplary two-thermocouple level control system in which the interface is at the level of the upper thermocouple.

FIG. 4C illustrates an exemplary two-thermocouple level control system in which the interface is above the level of the upper thermocouple.

FIG. 5 illustrates an exemplary level detection or control system including a plurality of thermocouples.

FIG. 6 illustrates another exemplary level control system.

FIG. 7A illustrates the vessel of FIG. 6.

FIG. 7B is a picture of the vessel of FIG. 6.

FIG. 8 illustrates an exemplary method of controlling the position of the interface in the level control system of FIG. 6.

FIGS. 9A and 9B are related to Example 1 and illustrate the stability of the interface position in the vessel of 7B during a level control test.

FIG. 10A is related to Example 1 and shows the temperatures recorded during the level control test.

FIG. 10B is related to Example 1 and shows the inlet and outlet flow rates recorded during the level control test.

FIG. 10C is related to Example 1 and shows the amount of material lost to evaporation during the level control test.

FIG. 11A illustrates another exemplary level control system.

FIG. 11B illustrates the vessel of FIG. 11A.

FIG. 12 is related to Example 2 and shows the inlet and outlet flow rates during the level control test.

FIG. 13 is related to Example 2 and shows the temperatures recorded during the level control test.

### DETAILED DESCRIPTION

The present disclosure provides methods for determining and/or controlling the level of liquid in a vessel using temperature. Although not so limited, the present disclosure provides a method of controlling a liquid level in a continuous reactor.

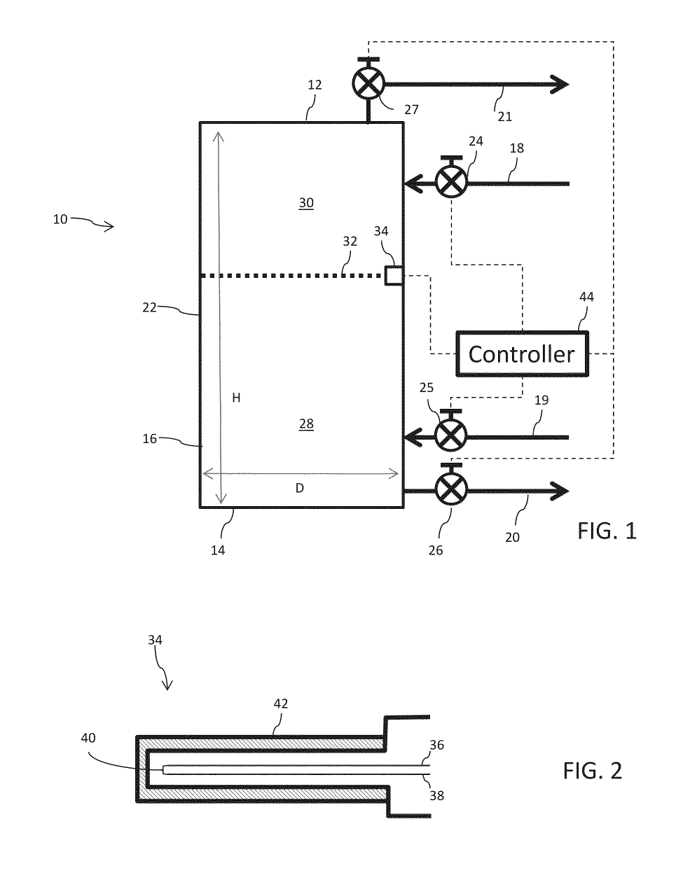

Referring first to FIG. 1, an exemplary level control system is illustrated for a vessel 10. Exemplary vessels 10 include storage vessels, reactor vessels, batch reactor vessels, back mixed reactor vessels, semi-batch reactor vessels, continuous stirred tank reactor (CSTR) vessels, and continuous reactor vessels. In one exemplary embodiment, vessel 10 is a portion of a distillation column, including a continuous distillation column. Vessel 10 illustratively includes a top 12, bottom 14, and at least one vessel wall 16. Vessel 10 includes at least one inlet 18 and at least one outlet 20. In one exemplary embodiment, vessel 10 is open to the environment at top 12. In another exemplary embodiment, vessel is closed to the environment at top 12.

In some exemplary embodiments, vessel 10 has a nominal volume of as large as about 10 L, 100 L, 500 L, 1,000 L, 100,000 L, 1,000,000 L, 5,000,000 L, or larger, or within any range defined between any two of the foregoing values. In some exemplary embodiments, vessel 10 has a nominal volume of as large as about 5 L, about 2 L, about 1 L, about 500 mL, about 400 mL, about 200 mL, about 150 mL, as small as about 100 mL, about 50 mL, about 25 mL, about 10 mL, about 1 mL or less, or within any range defined between any two of the foregoing values.

The interior of vessel 10 illustratively has a height H and a diameter D, which define a height to diameter ratio H/D. In some exemplary embodiments, vessel 10 has an H/D ratio as low as 0.1, 0.3, 0.5, 0.6, 0.8, 1.0, 1.2, as high as 1.4, 1.5, 2.0, 3.0, 5.0, 10.0, or within any range defined between any two of the foregoing values.

Although illustratively positioned near top 12 of vessel 10, in other embodiments, inlet 18 may be positioned between the top 12 and a midpoint 22 of vessel 10, at midpoint 22 of vessel 10, between the midpoint 22 and bottom 14 of vessel 10, or at the bottom 14 of vessel 10. Flow of material through inlet 18 into vessel 10 may be controlled by one or more inlet control valves 24.

Although illustratively positioned near bottom 14 of vessel 10, in other embodiments, outlet 20 may be positioned between the bottom 14 and a midpoint 22 of vessel 10, at midpoint 22 of vessel 10, between the midpoint 22 and top 12 of vessel 10, or at the top 12 of vessel 10. Flow of material through outlet 20 out of vessel 10 may be controlled by one or more outlet control valves 26.

In operation, vessel 10 may include a first component 28 and a second component 30 separated by an interface 32. In one embodiment, first component 28 is a liquid and second component 30 is a gas. In another embodiment, first component 28 is a flowable solid or solid/liquid mixture such as a slurry, a suspension, an emulsion, a powder, or a granular material, and second component 30 is a liquid, a liquid vapor at elevated temperatures, or a gas. In another embodiment, first and second components 28, 30 are immiscible liquids.

As illustrated in FIG. 1, vessel 10 includes a second inlet 19 and a second outlet 21. Flow of material through second inlet 19 into vessel 10 is illustratively controlled by second inlet control valve 25. Flow of material through second outlet 21 from vessel 10 is illustratively controlled by second outlet control valve 27. In one exemplary embodiment, inlet 18 provides first component 28 to vessel 10 and second inlet 19 provides second component 30 to vessel 10. At least a portion of first component 28 is removed from vessel 10 through outlet 20, and at least a portion of second component is removed from vessel 10 through outlet 21. In one embodiment, the top 12 of vessel 10 is open, outlet 21 is to the atmosphere, and no second outlet control valve 27 is utilized. Although illustrated as valves, in other exemplary embodiments, valves 24, 25, 26, and 27 may be pumps, solid or particle conveyors, or other suitable elements.

One or more temperature sensors 34, are provided in the interior of vessel 10. Temperature sensor 34 is illustratively a thermocouple. Referring next to FIG. 2, an exemplary thermocouple 34 is illustrated. Thermocouple 34 comprises two dissimilar metals, 36, 38, coupled together at a distal end 40 of the thermocouple. A voltage is produced from heating or cooling the joined metals, which is associated with a particular temperature. Exemplary thermocouples include types J, K, T, and E thermocouples, available from Omega Engineering.

Other suitable temperature sensors 34 include thermometers having an analog or digital output, IR detectors, and thermistors. Thermocouple 34 is illustratively operatively coupled to controller 44. Although illustrated as coupled to the wall 16 of vessel 10, in some embodiments, thermocouple 34 may be coupled to the top 12 or bottom 14 of vessel 10. In one embodiment, thermocouple 34 is exposed directly to the interior of vessel 10. In another embodiment, thermocouple 34 is positioned in a thermocouple well (not shown) provided in vessel 10. Although described above as a thermocouple 34, other suitable temperature sensors may also be used.

In one exemplary embodiment, the temperature sensors 34 are not heated thermocouples. Exemplary heated thermocouples include thermocouples having an interior or proximal heat source, differential heated thermocouples, heated junction thermocouples, and binary coding thermocouple (BICOTH) and ternary coding thermocouple (TRICOTH) systems.

In one embodiment, controller 44 determines the position of the interface 32 in vessel 10 as described in more detail below. In one embodiment, controller maintains the position of the interface 32 in vessel 10 by controlling the flow of one or more of first component 28 and second component 30 into or out of vessel 10.

As illustrated in FIG. 2, the thermocouple 34 may include sheathing 42 surrounding the thermocouple 34. Sheathing 42 may provide chemical and/or mechanical protection to thermocouple 34. An exemplary sheathing material is 316 stainless steel. In some embodiments, the sheathing may be as thin as 1.6 mm, 1.5 mm, 1.25 mm, 1.0 mm, 0.75 mm, 0.5 mm, 0.25 mm, 0.1 mm, 0.05 mm, 0.02 mm, 0.01 mm, or within any range defined between any two of the foregoing values. Generally, a thicker sheathing value provides more mechanical protection to thermocouple 34. Generally, thinner sheathing provides a faster response time for thermocouple 34. For example, in a non-corrosive environment, a thermocouple having no sheathing provides the fastest response time.

The ability of a temperature sensor, such as temperature sensor 34, to respond to a temperature change is the response time of the temperature sensor. In an exemplary embodiment, the response time, or time constant, of the temperature sensor is defined as the time required to reach 63.2% of an instantaneous temperature change. The response time of a temperature sensor may depend, in part, on the diameter of the temperature sensor, and the thickness of any sheathing surrounding the temperature sensor. In some embodiments, the response time of the temperature sensor is as short as 0.1 seconds, 0.2 seconds, 0.3 seconds, 0.4 seconds, 0.5 seconds, 0.6 seconds, 0.7 seconds, as long as 0.8 seconds, 0.9 seconds, 1 second, 1.25 seconds, 1.5 seconds, 1.75 seconds, 2 seconds, 3 seconds or higher, or within any range defined between any two of the foregoing values.

In some embodiments, the precision of controlling the position of interface 32 in vessel 10 is determined in part by the response time of the selected temperature sensor, the H/D ratio of the vessel 10, and the rate of flow of first material 28 and second material 30 into and out of vessel 10. Illustratively, a longer response time indicates a larger time before the temperature sensor 34 detects a change in temperature. In some embodiments, in which the position of interface 32 is desired to be controlled with a high degree of precision around temperature sensor 34, a temperature sensor 34 having a short response time, such as less than 1 second, is selected. In other embodiments, in which the precision of position of interface 32 around temperature sensor 34 is not desired to be controlled with such a high degree of precision, a temperature sensor 34 having a long response time, such as times up to 1 second, from 1 to 3 seconds, or higher, may be used, although shorter response times may also be used.

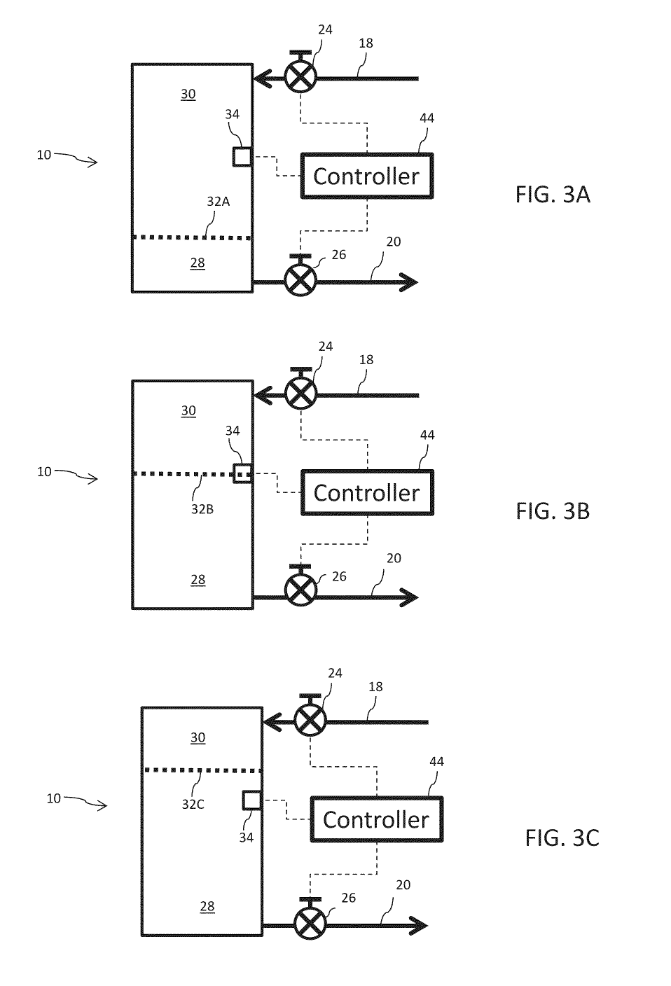

Referring next to FIGS. 3A-3C, the first component 28 and second component 30 are separated by interface 32. In an illustrative embodiment, the temperature of the first component 28 is different than that of second component 30. Exemplary differences in the temperature of the first component 28 and second component 30 may be due to the temperature of the vessel 10 and density of the first and second components 28, 30, differences in the incoming temperature of each material, a temperature gradient within vessel 10, or heat caused from an endothermic reaction, an exothermic reaction, or mixing of the materials.

When interface 32 is at a first position 32A below that of the thermocouple 34, as illustrated in FIG. 3A, the thermocouple 34 produces a voltage read by controller 44 associated with the temperature of the second component 30. When interface 32 is at a second position 32B at that of the thermocouple 34, as illustrated in FIG. 3B, the thermocouple 34 begins detecting a change in temperature from the temperature of the second component 30 to that of the first component 28. This change in temperature is detected as a change in voltage by controller 44. When interface 32 is at a third position 32C above that of the thermocouple 34, as illustrated in FIG. 3C, the thermocouple 34 produces a voltage read by the controller 44 associated with the temperature of the first component 28.

In one embodiment, controller 44 has been programmed with the temperature of the first component 28 and/or the temperature of the second component 30. Based on the output voltage of the thermocouple 34, controller 44 determines whether the current level of the interface 32 is below, above, or at the level of the thermocouple 34.

In one embodiment, controller 44 monitors the output voltage of the thermocouple 34 and determines when the level of the interface 32 has risen to the level of thermocouple 34 or fallen to the level of thermocouple 34 based on a change in output voltage from the thermocouple 34.

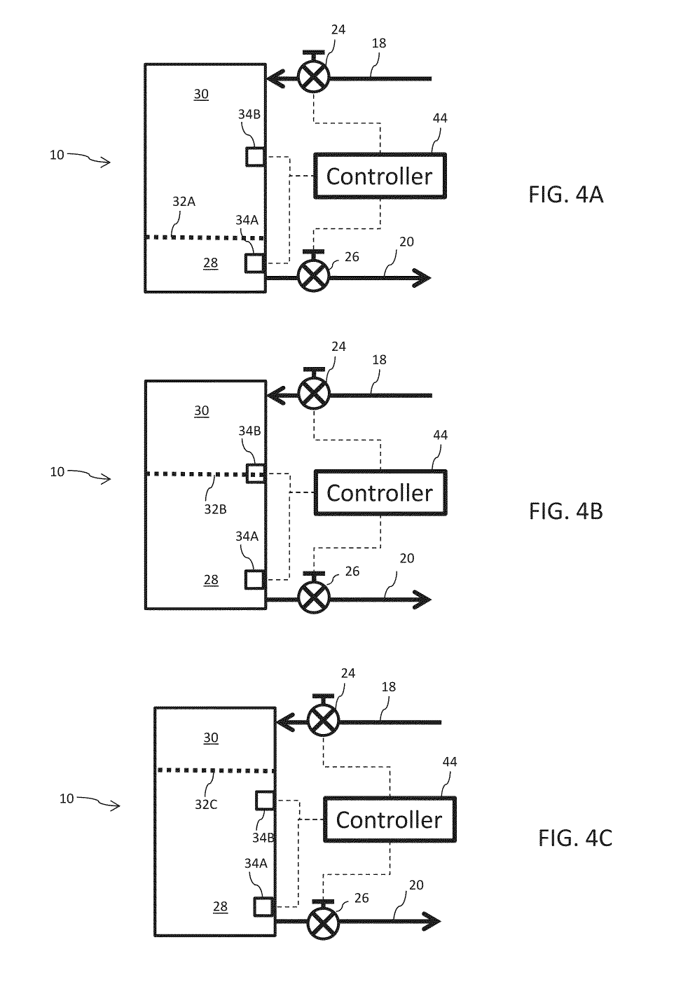

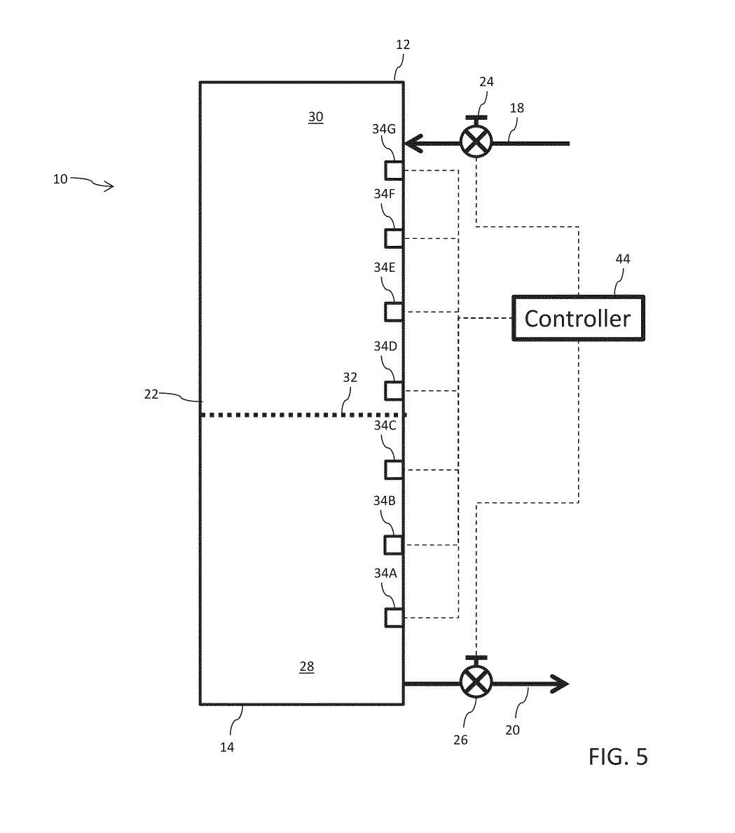

Referring next to FIGS. 4A-4C, an exemplary two-thermocouple system is illustrated. As in FIGS. 3A-3C, the first component 28 and second component 30 are separated by interface 32. As shown in FIGS. 4A-4C, vessel 10 includes a first thermocouple 34A and a second thermocouple 34B. First thermocouple 34A is illustratively placed at a position below that of second thermocouple 34B. In an illustrative embodiment, the temperature of the first component 28 is different than that of second component 30.

When interface 32 is at a first position 32A between that of the first thermocouple 34A and the second thermocouple 34B, as illustrated in FIG. 4A, the first thermocouple 34A produces a first voltage read by controller 44 associated with the temperature of the first component 28 and the second thermocouple 34B produces a second voltage associated with the temperature of the second component 30. When interface 32 is at a second position 32B at that of the second thermocouple 34B, as illustrated in FIG. 4B, the first thermocouple produces a first voltage associated with the temperature of the first component 28, and the second thermocouple 34B registers a change in temperature from the temperature of the second component 30 towards that of the first component 28. This change in temperature is detected as a change in voltage by controller 44. When interface 32 is at a third position 32C above that of the second thermocouple 34B, as illustrated in FIG. 4C, the both first and second thermocouples 34A, 34B produce a voltage associated with the temperature of the first component 28.

In one embodiment, the controller 44 determines the level of the interface 32 based solely on the second thermocouple 34B, as described with reference to FIGS. 3A-3C above.

In one embodiment, the controller 44 determines the level of the interface 32 based on a difference between the reading of the first thermocouple 34A and the reading of the second thermocouple 34B. In a more particular embodiment, when the temperature as determined by the first thermocouple 34A is the same as the temperature as determined by the second thermocouple 34B, the controller determines that the interface level is above the level of the second thermocouple 34B. When the temperature as determined by the first thermocouple 34A is different than the temperature as determined by the second thermocouple 34B, the controller determines that the interface level is between the level of the first thermocouple 34A and second thermocouple 34B. When the temperature of the second thermocouple 34B is changing, the controller determines that the interface level is at the level of the second thermocouple 34B.

In one embodiment, the first and second thermocouples are paired thermocouples, having similar voltage readings at the same temperature. In one embodiment, the first and second thermocouples are not paired, but controller 44 correlates the voltage associated with one thermocouple at a given temperature with the voltage associated with the other thermocouple at the same temperature.

Referring next to FIG. 5, an exemplary level detection system using a plurality of thermocouples 34A-34G is illustrated. Vessel 10 includes a first component 28 and second component 30 separated by interface 32, as described above. Vessel 10 includes a plurality of thermocouples 34, illustratively seven thermocouples 34A-34G, positioned at various heights within the interior of vessel 10. Each thermocouple 34A-34G is operatively coupled to controller 44. Controller 44 monitors the output of each thermocouple 34A-34G. A difference in temperature between two thermocouples 34A-34G is determined to correspond to the interface being at a position between the two thermocouples 34A-34G. For example, in the exemplary embodiment illustrated in FIG. 5, each of thermocouples 34A-34C would have a voltage output corresponding to the temperature of first component 28, while each of thermocouples 34D-34G would have a voltage output corresponding to the temperature of second component 30. Controller 44 would determine that the position of interface 32 was between the positions of thermocouples 34C and 34D.

In one embodiment, controller 44 includes a processor and access to non-volatile memory. Controller 44 illustratively includes one or more control programs. Illustrative control programs include programs based on proportional control, proportional integral control, proportional derivative control, proportional integral derivative control, proportional integral derivative offset control, and other suitable programs.

In one embodiment, controller 44 is provided with a level set point. In the exemplary embodiment illustrated in FIG. 1, the level set point may be at the position of the thermocouple 34. In the exemplary embodiment illustrated in FIGS. 3A-3C, the level set point may be at the position of second thermocouple 34B, or the range between the first thermocouple 34A and the second thermocouple 34B. In the exemplary embodiment illustrated in FIG. 5, the level set point may be at the position of any of the thermocouples 34A-34G, or at a range between any two adjacent thermocouples.

In one embodiment, if controller 44 determines that the level of interface 32 is below the set point, controller 44 increases the flow of first component 28 into vessel 10 through inlet 18 by further opening valve 24, and/or decreases the flow of first component 28 out of vessel 10 through outlet 20 by further closing valve 26. In some embodiments, controller 44 also adjusts the flow of second component 30 into or out of the vessel 10 through similar means.

In one embodiment, if controller 44 determines that the level of interface 32 is above the set point, controller 44 decreases the flow of first component 28 into vessel 10 through inlet 18 by further closing valve 24, and/or increases the flow of first component 28 out of vessel 10 through outlet 20 by further opening valve 26. In some embodiments, controller 44 also adjusts the flow of second component 30 into or out of the vessel 10 through similar means.

Referring again to FIG. 1, in some embodiments, controller 44 maintains the position of the interface 32 substantially at the level of the temperature sensor 34 by increasing and decreasing the flow through outlet 20 to oscillate the position of the interface 34 in a relatively narrow range about the position of the temperature sensor 34. In some exemplary embodiments, the range of oscillation is as large as about 5° C., about 2° C., 1° C., as small as about 0.5° C., 0.2° C., or smaller, or within any range defined between any two of the foregoing values. In some embodiments, controller 44 maintains the position of interface 32 within a range of about 10%, about 5%, about 2%, about 1%, about 0.1%, about 0.01%, about 0.001%, about 0.0001%, or smaller, of the height of vessel 10, or within any range defined between any two of the foregoing values.

Additionally, controller 44 may include one or more data integrity routines. In one embodiment, with reference to FIG. 5, if two non-adjacent thermocouples, illustratively thermocouple 34A and 34C, provide a voltage output corresponding to the same temperature, but an intermediary thermocouple, illustratively thermocouple 34B, provides an output voltage corresponding to a different temperature, controller 44 may log an error message or update a status to require maintenance on the system.

In one embodiment, the thermocouple nearest the top 12 of vessel 10, illustratively thermocouple 34G in FIG. 5, may be utilized by the controller to shut off the reactor if the interface 32 is detected at the high level in vessel 10 prior to the material overflowing the vessel 10. Similarly, the thermocouple nearest the bottom 14 of vessel 10, illustratively thermocouple 34A in FIG. 5, may be utilized by the controller to shut of the reactor as indicating a leak if the interface 32 is detected at such a low level.

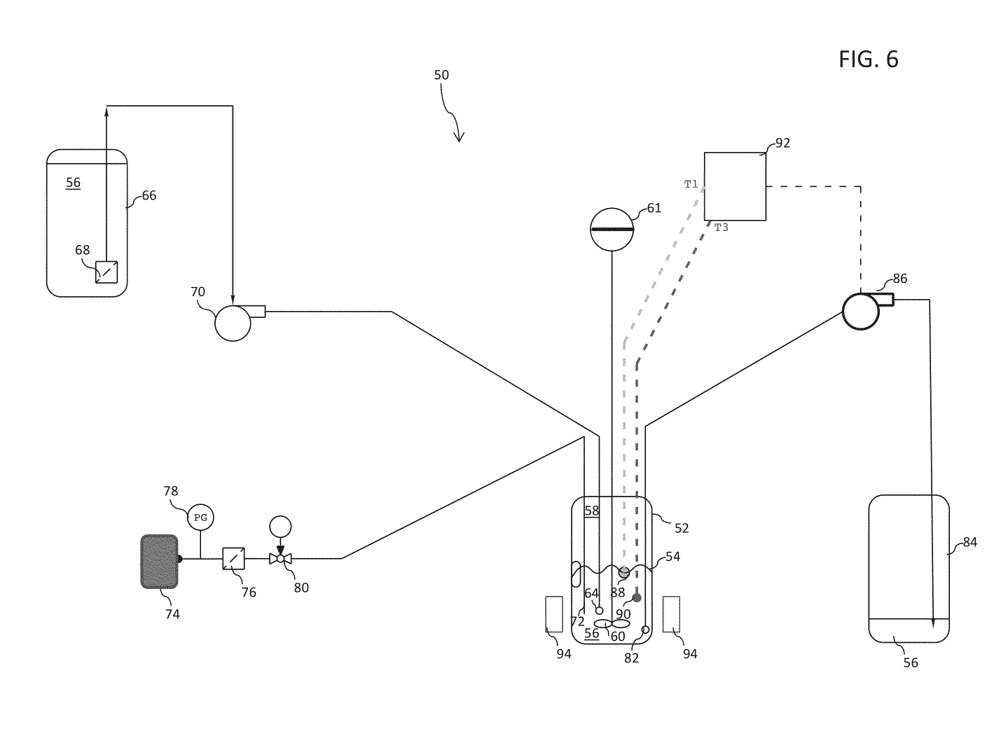

Referring next to FIG. 6, a schematic of another exemplary level control system 50 is provided. Level control system 50 is similar to level control system 10. The level control system 50 includes a vessel 52.

In some exemplary embodiments, vessel 52 has a nominal volume of as large as about 10 L, 100 L, 500 L, 1,000 L, 5,000 L, 50,000 L, 100,000 L, 1,000,000 L, 5,000,000 L, or larger, or within any range defined between any two of the foregoing values. In some exemplary embodiments, vessel 52 has a nominal volume of as large as about 5 L, about 2 L, about 1 L, about 500 mL, about 400 mL, about 200 mL, about 150 mL, as small as about 100 mL, about 50 mL, about 25 mL, about 10 mL, about 1 mL or less, or within any range defined between any two of the foregoing values.

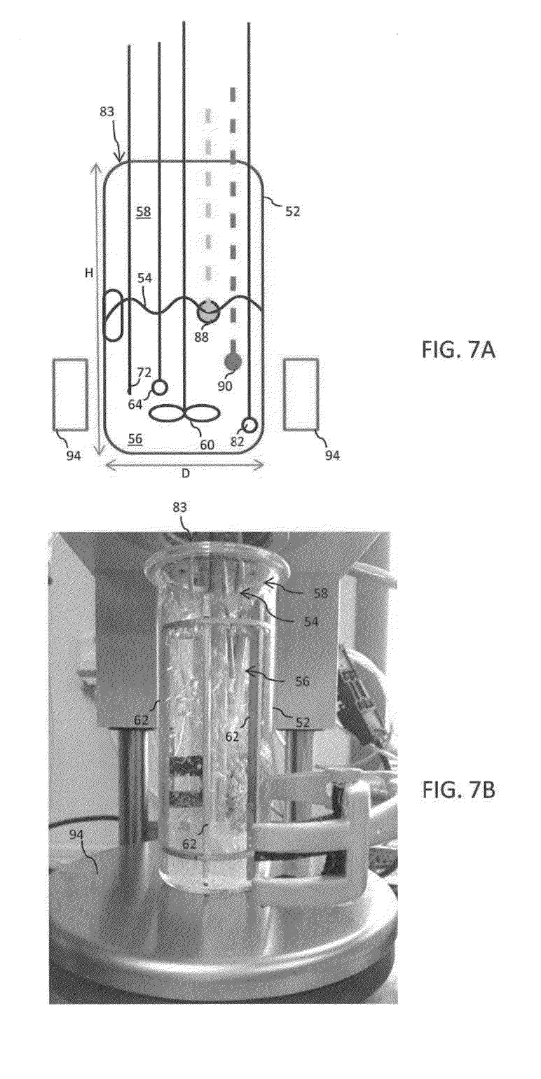

Referring next to FIG. 7A, the interior of vessel 52 illustratively has a height H and a diameter D, which define a height to diameter ratio H/D. In some exemplary embodiments, vessel 52 has an H/D ratio as low as 0.1, 0.3, 0.5, 0.6, 0.8, 1.0, 1.2, as high as 1.4, 1.5, 2.0, 3.0, 5.0, 10.0, or within any range defined between any two of the foregoing values.

Vessel 52 illustratively includes an interface 54 between a first component 56 and a second component 58. In one embodiment, first component 56 is a liquid and second component 58 is a gas. In another embodiment, first component 56 is a flowable solid or solid/liquid mixture such as a slurry, a suspension, an emulsion, a powder, or a granular material, and second component 58 is a liquid or a gas. In another embodiment, first and second components 56, 58 are immiscible liquids.

In one embodiment, second component 58 is open to the environment in vessel 52. In another embodiment, vessel 52 is enclosed and may be pressurized.

As illustrated in FIGS. 7A and 7B, vessel 52 includes impeller 60 positioned within first component 56 to stir the contents of vessel 52. Impeller 60 is illustratively connected to a mechanical power source 61 to turn impeller 60 at a predetermined rotational speed. Vessel 52 further includes a plurality of baffles 62 (FIG. 7B) around an interior surface of the vessel to prevent the formation of a vortex due to the stirring of impeller 60.

Referring again to FIG. 7A, vessel 52 illustratively includes first inlet 64 for providing the first component 56 to the interior of vessel 52. First inlet 64 illustratively provides first component 56 at a position below the desired level of interface 54. In other embodiments, first inlet 64 provides first component 56 at a position at or above the desired level of interface 54.

As shown in FIG. 6, first component 56 is illustratively a liquid supplied from a liquid supply vessel 66 through filter 68 to first inlet 64. The flow rate of the first component 56 into first inlet 64 is controlled by pump 70. In one exemplary embodiment, pump 70 is a High Performance Liquid Chromatography (HPLC) pump.

Referring again to FIG. 7A, vessel 52 illustratively includes second inlet 72 for providing the second component 58 to the interior of vessel 52. Second inlet 72 illustratively provides second component 58 at a position below the desired level of interface 54. In other embodiments, second inlet 72 provides second component 58 at a position at or above the desired level of interface 54.

As shown in FIG. 6, second component 58 is illustratively a compressed gas supplied from a pressurized gas supply 74 through filter 76 to first inlet 64. Pressurized gas supply 74 illustratively includes pressure gauge 78. The flow rate of the second component 58 into first inlet 72 is controlled by flow control valve 80.

Referring again to FIG. 7A, vessel 52 illustratively includes outlet 82 for removing either first component 56 or second component 58 from the interior of vessel 52. Outlet 82 illustratively is positioned below the desired level of interface 54 to remove first component 56 from the vessel 52. In other embodiments, outlet 82 is positioned at or the desired level of interface 54 to remove a mixture of the first component 56 and second component 58 or above the desired level of the interface 56 to remove only the second component 58.

In the illustrated embodiment, a second outlet 83 is provided as the open top of vessel 52. In other embodiments, vessel 52 includes a closed top, and a separate second outlet 83 is provided. As illustrated at least a portion of second component 58 is removed through second outlet 83. In some embodiments, a portion of first component 56 is also removed through the second outlet 83, such as through evaporation.

As shown in FIG. 6, outlet 82 is fluidly connected to collection vessel 84. The flow rate of the first component 56 from the output 82 is controlled by pump 86. In one exemplary embodiment, pump 70 is an HPLC pump. In the illustrated embodiment, the operation of pump 70 and/or pump 86 is controlled by controller 92.

As first and second components 56, 58 are added to vessel 52 through first and second inlets 64, 72 and removed through outlet 82, the position of the interface 54 may oscillate around a given position. In some embodiments, the stirring of the contents of vessel 52 by impeller 60 provides a non-uniform surface of interface 54, where the interface is substantially at a given level.

Referring again to FIG. 7A, vessel 52 further includes first temperature sensor 88 and second temperature sensor 90. Exemplary temperature sensors include thermocouples, such as thermocouples 34, thermometers, IR detectors, thermistors, and other suitable temperature sensors. In a more particular embodiment, first and second temperature sensors 88, 90, are 0.5 mm diameter K-type thermocouples, available from Omega Engineering, having a sheathing of Hastelloy or 316 stainless steel covering the exposed thermocouple wires.

First temperature sensor 88 is illustratively positioned below the desired level of the interface 54, while second temperature sensor 90 is illustratively positioned at the desired level of the interface 54.

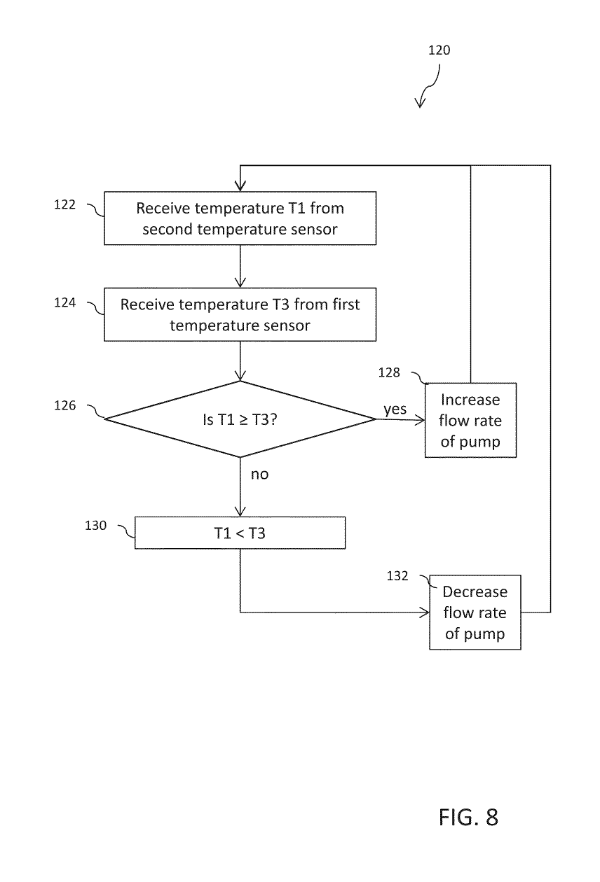

As shown in FIG. 6, first temperature sensor 88 and second temperature sensor 90 are operatively connected to controller 92. Controller 92 illustratively controls the position of the interface 54 by adjusting the flow rate of pump 86 (see FIGS. 6 and 8). In one embodiment, controller 92 has proportional-integral-derivative (“PID”) functionality, although other suitable controllers, including but not limited to controllers with proportional, proportional-integral, proportional-derivative, and offset functionality, may also be used.

In one exemplary embodiment, as the amount of first component 56 in vessel 52 increases, the position of the interface 54 approaches first temperature sensor 88. As the position of the interface 54 begins to approach first temperature sensor 88, controller 92 illustratively detects the proximity of first component 56 to first temperature sensor 88. First temperature sensor 88 may detect the proximity of first component 56 due to direct contact of first component 56 with first temperature sensor 88, or from heat conducted, radiated, or dissipated from first component 56 to second component 58 or from second component 58 to first component 56 in an area of second component 58 proximal to interface 54. In one illustrative embodiment, controller 92 detects the proximity of first component 56 by detecting a change in the temperature reported by first temperature sensor 88 as the first component 56 begins to contact the first temperature sensor 88. In another illustrative embodiment, controller 92 detects the proximity of first component 56 by detecting a change in the difference between first temperature sensor 88 and second temperature sensor 90 as the first component 56 begins to approach the first temperature sensor 88 and the temperature reported by the first temperature sensor 88 begins to approach that of the second temperature sensor 90. Upon determining that the rising level of the interface 54 is substantially at the level of the first temperature sensor 88, controller 92 increases the flow of pump 86.

As the position of the interface 54 begins to fall below that of the first temperature sensor 88, controller 92 illustratively detects the proximity of second component 58 to first temperature sensor 88. Second temperature sensor 90 may detect the proximity of second component 58 due to direct contact of second component 58 with second temperature sensor 90, or from heat conducted, radiated, or dissipated from first component 56 to second component 58 or from second component 58 to first component 56 in an area of first component 56 proximal to interface 54. In one illustrative embodiment, controller 92 detects the decrease in proximity of second component 58 by detecting a change in the temperature reported by first temperature sensor 88 as the second component 58 begins to lose contact with the first temperature sensor 88. In another illustrative embodiment, controller 92 detects the change in proximity of second component 58 by detecting a change in the difference between first temperature sensor 88 and second temperature sensor 90 as the second component 58 begins to lose contact with the first temperature sensor 88 and the temperature reported by the first temperature sensor 88 begins to diverge from that of the second temperature sensor 90. Upon determining that the falling level of the interface 54 is substantially at the level of the first temperature sensor 88, controller 92 decreases the flow of pump 86.

In another illustrative embodiment, the flow of pump 86 is held constant, and the position of interface 54 is maintained by adjusting the inlet flow of the first component by adjusting the flow of pump 70. Upon determining that the rising level of the interface 54 is substantially at the level of the first temperature sensor 88, controller 92 decreases the flow of pump 70. Upon determining that the falling level of the interface 54 is substantially at the level of the first temperature sensor 88, controller 92 increases the flow of pump 70.

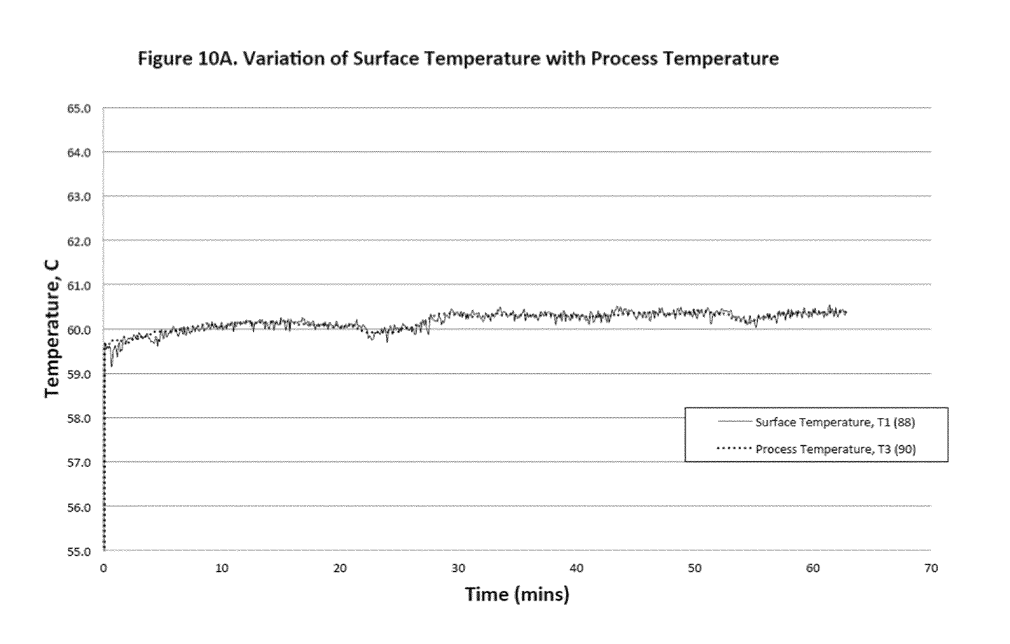

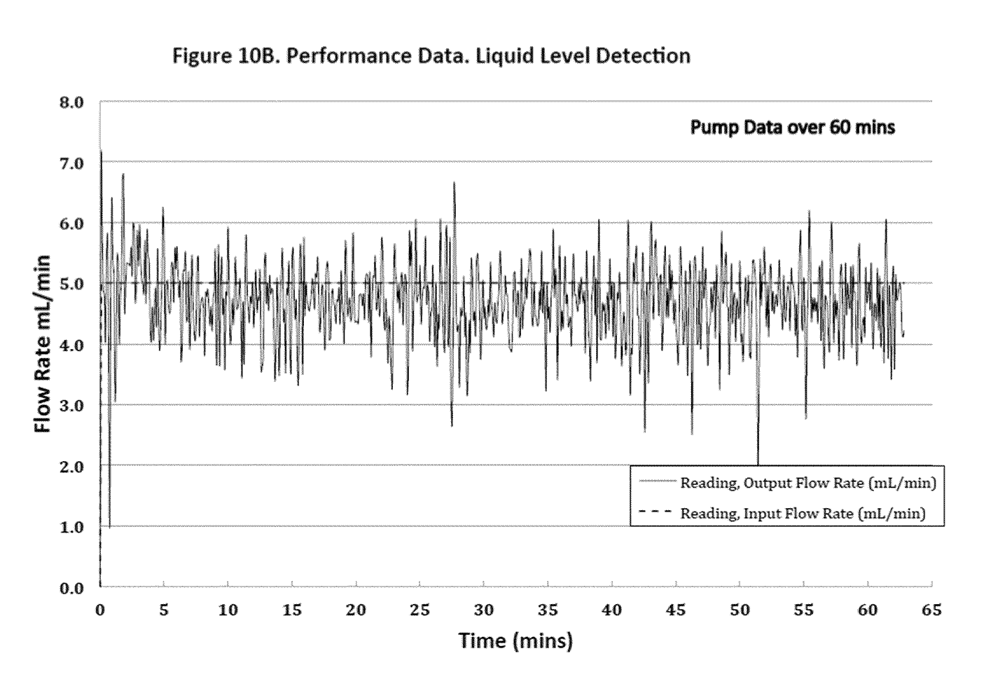

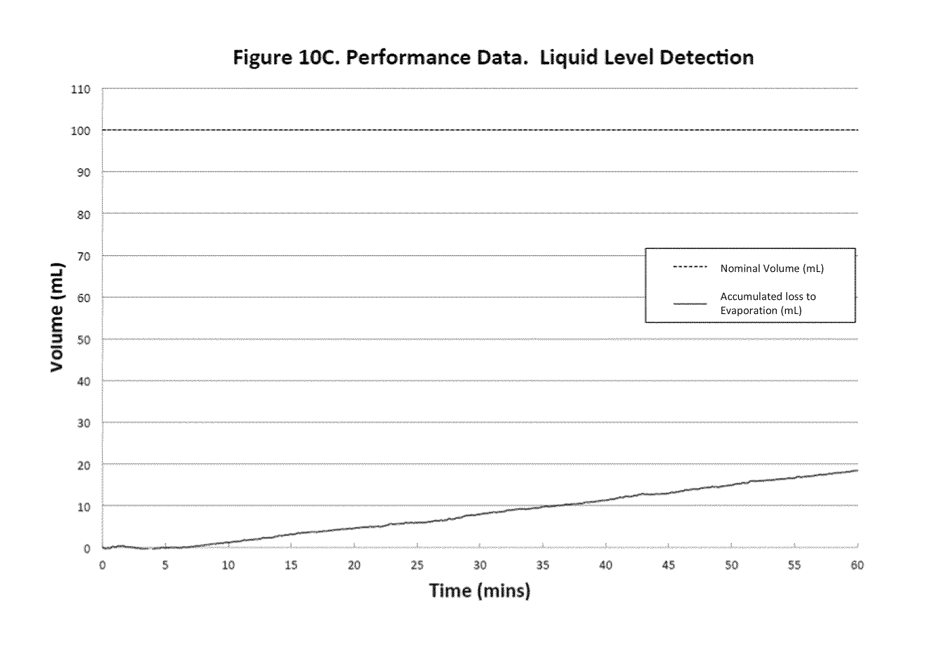

In this exemplary embodiment, the controller 92 maintains the position of the interface 54 substantially at the level of the first temperature sensor 88 by increasing and decreasing the flow of pump 86 and/or pump 70 to oscillate the position of the interface 56 in a relatively narrow range about the position of the first temperature sensor 88 (see e.g. FIGS. 10A and 10B). In some exemplary embodiments, the range of oscillation is as large as about 50° C., about 10° C., about 5° C., about 2° C., about 1° C., as small as about 0.5° C., about 0.2° C., about 0.1° C., or smaller, or within any range defined between any two of the foregoing values. In some embodiments, controller 92 maintains the position of interface 56 within a range of about 1%, about 0.1%, about 0.01%, about 0.001%, about 0.0001%, or smaller, of the H/D ratio of vessel 56, or within any range defined between any two of the foregoing values.

In the illustrative embodiment shown in FIGS. 6 and 7A, the vessel 52 is heated by heater 94. Although illustrated as heating the portion of vessel 52 containing first component 56, in other embodiments, heater 94 may heat the portion of vessel 52 containing second component 58, the entire vessel 52, or pre-heating first component 56 and/or second component 58 before they enter vessel 52. In other embodiments, at least a portion of vessel 52 may be cooled by a chiller or other suitable heat exchanger.

In the illustrative embodiment, the movement of first component 56 by impeller 60, along with first inlet 64 and/or second inlet 72, provides for a more uniform temperature throughout first component 56. In some embodiments, a more uniform temperature within first component 56 provides better control of the position of interface 56.

### Example 1

The level control system 50 as illustrated in FIG. 6 was tested to determine the stability of the interface 54 position. The first component 56 was isopropanol and pump 70 was set to deliver 5 mL/minute of isopropanol to vessel 52 through first inlet 64. The second component 58 was pressurized air and flow control valve was set to deliver 227 mL/min of air (as measured at 20° C. and 1 atm. Vessel 52 was open to the environment, and the test proceeded at ambient pressure. Heater 94 was set to 60° C., ensuring that the isopropanol first component 56 would be warmer than the air second component 58.

Referring to FIG. 8, the controller 92 illustratively used method 120 to maintain the position of the interface 54 by adjusting the outlet flow rate from the vessel. In block 122, controller 92 received the temperature T1 from the second temperature sensor 90 indicating the temperature at the desired position of interface 54. In block 124, controller 92 received the temperature T3 from the first temperature sensor 88, indicating the temperature in the first component 56. In block 126, the controller 92 compared T1 and T3. If T1 was greater than or equal to T3 in block 126, in block 128 the flow rate of the pump 86 was increased, increasing the flow rate out of vessel 52 and lowering the position of interface 54. If T1 was less than T3 as shown in block 130, in block 132 the flow rate of the pump 86 was decreased, decreasing the flow rate out of vessel 52 and raising the position of interface 54. The method 120 then returned to block 122 and began again.

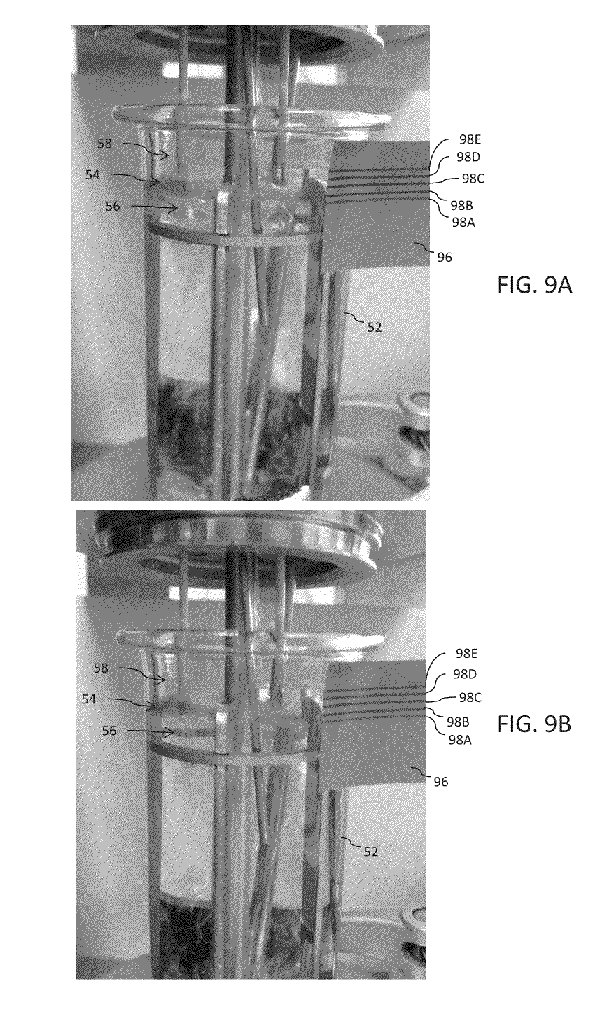

Referring next to FIG. 9A, the vessel 52 is illustrated at the start of the test. A height indicator 96 containing a plurality of level lines 98A-98E is shown coupled to the side of vessel 52. At the start of the test, the interface 54 is approximately level with level line 98B. Referring next to FIG. 9B, the same vessel 52 and height indicator 96 is shown after 30 minutes of the test. As shown in FIG. 9B, the interface 54 is still approximately level with level line 98B, and no change to the position of the interface 54 is perceptible. The inlet flow rate of isopropanol (first component 56) was set to 5 mL/min, and the inlet flow of pressurized air (second component 58) was set to 227 mL/min (as measured at 20° C. and 1 atm). The controller 92 adjusted the flow of pump 86 according to method 120. The method 120 was determined to provide good level control by adjusting the outlet flow rate from the vessel based on the temperature readings from the first and second temperature sensors 88, 90.

Referring next to FIGS. 7A and 10A, the output of the surface temperature T1 from the first temperature sensor 88 and the process temperature T3 from the second temperature sensor 90 is provided for the duration of the test. As shown in FIG. 10A, the surface temperature T1 oscillates around the process temperature T3 depending on the position of the liquid level. Referring next to FIG. 10B, the controller 92 increased or decreased the flow rate though outlet 82 based on the difference between T1 and T3 determined in method 120.

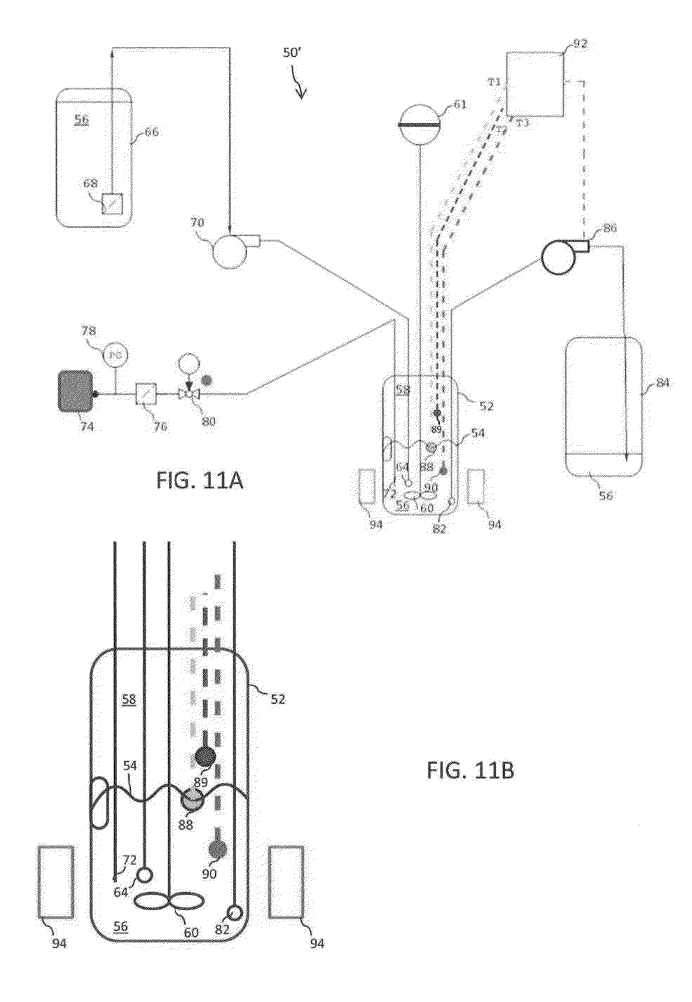

Referring next to FIG. 100, some evaporation from the vessel 52 was observed. The flow rate of isopropanol into vessel 52 through the first inlet 64 was greater than the flow rate of isopropanol out of vessel 52 through the outlet 82. Because the position of the interface 54 was maintained using method 120, the nominal volume of isopropanol in vessel 52 did not change. The difference in the flow rates was the amount of isopropanol lost out the top of vessel 52 due to evaporation. The cumulative loss over time is illustrated in FIG. 11 as the evaporation rate. Even with the observed evaporation of isopropanol, method 120 maintained the position of the interface 54 in vessel 52 over the observed period of the test.

### Example 2

Referring next to FIGS. 11A and 11B, another exemplary level control system 50′ is illustrated. Level control system 50′ is similar to level control system 50 illustrated in FIGS. 6 and 7A, and similar numbers are used to designate similar parts. Level control system 50′ includes a third temperature sensor 89. Third temperature sensor 89 is similar to first temperature sensor 88 and second temperature sensor 90. Exemplary temperature sensors include thermocouples, such as thermocouples 34, thermometers, IR detectors, thermistors, and other suitable temperature sensors. In a more particular embodiment, third temperature sensors 89 is a 0.5 mm diameter K-type thermocouples, available from Omega Engineering, having a sheathing of Hastelloy or 316 stainless steel covering the exposed thermocouple wires. In the exemplary embodiment illustrated in FIGS. 11A and 11B, first temperature sensor 88 is positioned below the desired level of the interface 54, second temperature sensor 90 is positioned at the desired level of the interface 54, and third temperature sensor 89 is positioned above the desired level of the interface 54. In a more particular embodiment, third temperature sensor 89 is positioned about 2 mm higher than the first temperature sensor 88. Third temperature sensor is illustratively operatively connected to controller 92. Controller 92 illustratively controls the position of the interface 54 by adjusting the flow rate of pump 86. Third temperature sensor 89 can be used to maintain the position of the interface 43 between positions 88 and 89 using a similar logic algorithm as shown in FIG. 8. Alternatively, third temperature sensor 89 can be used to monitor the liquid level and trigger an alarm indicating the presence of an abnormally high or abnormally low position of interface 54, or some other warning condition. Suitable measures can be taken following the activation of the warning condition.

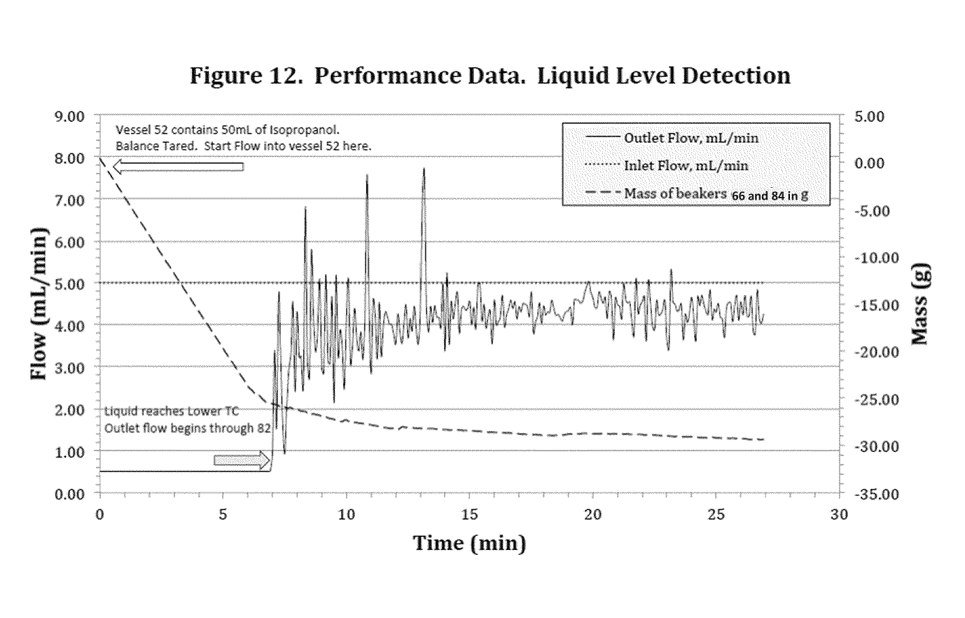

Referring to FIGS. 11A, 11B, and 12, vessel 66 was filled with isopropanol. Vessel 66 and vessel 88 were placed on a mass balance and tared. Vessel 52 contained about 50 mL of isopropanol, positioning the interface 52 below the first temperature sensor 88 but above the second temperature sensor 90. The pump 70 was set to deliver 5 mL/minute of isopropanol to vessel 52 through first inlet 64, and the balance output was recorded as a function of time. Pressurized air was delivered through the second inlet 72 at a rate of 390 mL/min (as measured at 20° C. and 1 atm). As shown in FIG. 12, the inlet flow of isopropanol was a constant 5 mL/minute for the duration of the test. As isopropanol was added to the vessel 52, the balance recorded an increasingly negative value.

For the first few minutes, the interface 54 was below the first temperature sensor 88. At about seven minutes, the interface 54 reached the first temperature sensor 88, and the pump began removing isopropanol from the vessel 52 through outlet 82.

As shown by the outlet flow in FIG. 12, the controller 92 adjusted the flow rate leaving the vessel 52 through outlet 82. Between about ten and fifteen minutes, the controller 92 achieved a relatively stable position of the interface 54, as indicated by the converging outlet flow level towards the inlet flow level and the relatively small magnitude of change in mass in vessels 66 and 84.

As can be seen in FIG. 12, even once a stable interface 54 position has been achieved, the flow leaving vessel 52 through outlet 82 is less than that entering through first inlet 64. The difference in the flow rates was the amount of isopropanol lost out the top of vessel 52 due to evaporation. This is shown by the decrease in mass between vessels 66 and 84 in FIG. 12, as a constant level in vessel 52 would result in a constant total mass between vessels 66 and 84 if there were no losses through evaporation. Even with the observed evaporation of isopropanol, controller 92 maintained the position of the interface 54 in vessel 52 over the observed period of the test.

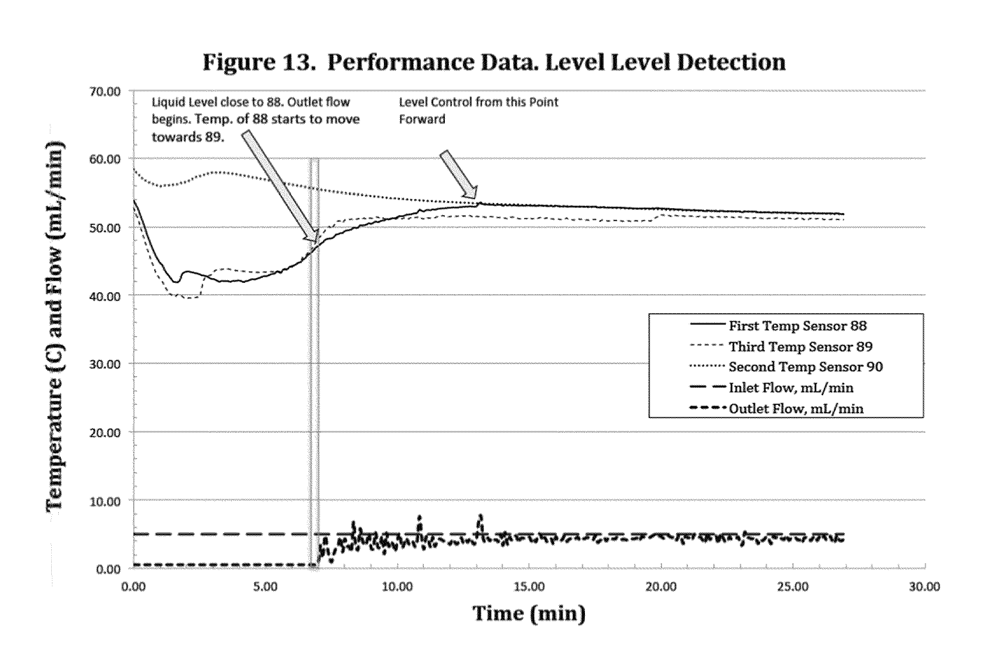

Referring next to FIG. 13, the inlet and outlet flows are shown with the temperatures recorded by the first temperature sensor 88, second temperature sensor 90, and third temperature sensor 89. As noted above, at about seven minutes, the first temperature sensor 88 sensed interface 54, and the pump 86 began removing isopropanol from the vessel 52 through outlet 82.

As the temperature recorded by the first temperature sensor 88 approaches the temperature of the second temperature sensor 90 at about fourteen minutes, the outlet flow starts to stabilize and follows the inlet flow.

When the temperature of the first temperature sensor 88 is greater or equal to the second temperature sensor 90, the outlet pump 86 increases the flow of isopropanol out of the vessel 52 through outlet 82. In this way the position of interface 54 oscillates about the position of the first temperature sensor 88. Between about ten and fifteen minutes, the controller 92 achieved a relatively stable position of the interface 54, as indicated by both the relatively small magnitude of outlet flow changes, and the convergence of the temperatures recorded by the first temperature sensor 88 and the second temperature sensor 90. As shown in FIG. 13, the temperature recorded by the third temperature sensor 89 after about ten minutes is less than that recorded by the first temperature sensor, even though the third temperature sensor 89 is positioned only about 2 mm above the desired level of the interface 54.

### Example 3

The level control system 50 as illustrated in FIG. 6 was tested to determine the effect of the response time of temperature sensors, such as first thermocouple 88, on the precision and stability of the interface 54 position. The first component 56 was isopropanol and pump 70 was set to deliver 5 mL/minute of isopropanol to vessel 52 through first inlet 64, as in Example 1. The second component 58 was pressurized air and flow control valve was set to deliver 227 mL/min of air (as measured at 20° C. and 1 atm. Vessel 52 was open to the environment, and the test proceeded at ambient pressure. Heater 94 was set to 60° C., ensuring that the isopropanol first component 56 would be warmer than the air second component 58.

First, a K-type thermocouple from Omega Engineering having a diameter of about ⅛ inch and a response time of about 1-3 seconds was used as first thermocouple 88. The position of interface 54 oscillated within a relatively large range.

Second, a K-type thermocouple from Omega Engineering having a diameter of about 0.5 mm (0.02 inches) diameter, a thin sheathing of 316 stainless steel and a response time of less than 1 second was used as first thermocouple 88. The position of interface 54 oscillated within a relatively small range.

While this invention has been described as relative to exemplary designs, the present invention may be further modified within the spirit and scope of this disclosure. Further, this application is intended to cover such departures from the present disclosure as come within known or customary practice in the art to which this invention pertains.

What is claimed is:

1. A method of controlling the level of a material in a vessel, comprising:
providing a first temperature sensor at a first position corresponding to a first level of material in the vessel;
monitoring the temperature recorded by the first temperature sensor, wherein a change in the monitored temperature indicates that the level of the material in the vessel is substantially at the first level; and
adjusting a flow of the material into the vessel or a flow of the material out of the vessel based on the change in the monitored temperature to maintain the level of material in the vessel at substantially the first level.

2. The method of claim 1, further comprising:
continuously adding a first flow rate of the material to the vessel;
wherein said adjusting includes increasing or decreasing the flow of the material out of the vessel based on the change in the monitored temperature.

3. The method of claim 2, wherein the material is a liquid.

4. The method of claim 3, further comprising evaporating at least a portion of the material from the vessel.

5. The method of claim 2, further comprising continuously adding a second flow rate of a second material to the vessel, the second material being chemically different than the first material, wherein an interface is formed between the liquid and the second material at the level of the liquid in the vessel.

6. The method of claim 5, wherein the second material is a gas.

7. The method of claim 6, further comprising reacting the second material with the first material in the vessel.

8. The method of claim 6, wherein the second material is added to the vessel at a position below the interface.

9. The method of claim 3, further comprising continuously stirring said material in the vessel.

10. The method of claim 1, wherein the vessel has a nominal volume of 1 L or less.

11. The method of claim 1, wherein the first temperature sensor is a thermocouple including a sheathing formed from stainless steel and having a thickness of 1.6 mm or less.

12. A method of controlling the level of a first material in a vessel, comprising:
receiving a first temperature reading corresponding to a first temperature from a first temperature sensor at a first position corresponding to a first level of the first material in the vessel;
receiving a second temperature reading corresponding to a second temperature from a second temperature sensor at a second position corresponding to a second level of the first material in the vessel, the second level being lower than the first level;
adding the first material to the vessel at a first inlet flow rate;
removing the first material from the vessel at a first outlet flow rate;
adjusting at least one of the first inlet flow rate and the first outlet flow rate based on the first and second temperature readings to maintain the level of the first material in the vessel at substantially the first level.

13. The method of claim 12, wherein said adjusting is based on a comparison of the first and second temperatures, a difference in the compared temperatures indicating that the level of the first material in the vessel is between the first level and the second level.

14. The method of claim 12, wherein said adjusting includes increasing the first outlet flow rate when the first temperature is greater than the second temperature and decreasing the first outlet flow rate when the second temperature is greater than the first temperature.

15. The method of claim 12, wherein the first temperature oscillates in a range above and below the second temperature.

16. The method of claim 15, wherein the oscillation range is about 1° C. or smaller.

17. The method of claim 12, further comprising adding a second material to the vessel at a second inlet flow rate, the second material being chemically different than the first material, wherein an interface is formed between the first material and the second material.

18. The method of claim 17, wherein the second material is a gas and adding the second material includes adding the gas to the vessel at a position below the interface.

19. The method of claim 12, further comprising receiving a third temperature from a third temperature sensor at a third position corresponding to a third level of the first material in the vessel, the third level being higher than the first level.

20. A method of determining the position of an interface between a first material and a second material in a vessel, comprising:
providing a first temperature sensor at a first position corresponding to a first level of the interface in the vessel;
providing a second temperature sensor at a second position corresponding to a second level of the interface in the vessel, the second level being lower than the first level; and
comparing the temperature recorded by the first temperature sensor and the second temperature sensor, wherein a difference in the temperatures indicates that the level of the interface in the vessel is between the first level and the second level, wherein the second material is chemically different than the first material.
